(19) United States
(12) Patent Application Publication
(10) Pub. No.: US 2026/0278130 A1
(43) Pub. Date: Sep. 17, 2026

(54) SYSTEMS AND METHODS FOR PASSIVE DETECTION OF WEB BROWSER UPLOAD AND DOWNLOAD ACTIVITY

(71) Applicant: Nuix Limited, Sydney (AU)

(72) Inventors: John Dwyer, Herndon, VA (US); Martin Pillion, Folsom, CA (US); Kevin Wenchel, Marriottsville, MD (US)

(21) Appl. No.: 19/078,101

(22) Filed: Mar. 12, 2025

(51) Int. Cl. G06F 21/62

(52) U.S. Cl. CPC G06F 21/6218

(57) ABSTRACT

Illustrative embodiments provide improved computer system security against exfiltration of electronic files (e.g., documents) from the computer system to an external location, and/or download of electronic files to the computer system from an external source, by using operating system facilities to passively observe a web browser application's activity, and the operating system's user accessibility features, to detect such upload and/or download, and read the content of the web browser's URL bar to identify unauthorized upload or download of files.

### TECHNICAL FIELD

The present disclosure relates to computer networks, and more particularly, to network security for upload and download of files using a web browser.

### BACKGROUND ART

It is known that a computer user can exfiltrate a document from a network by uploading the document to a remote source. For example, an unfaithful employee might use a web browser to upload a sensitive company document across the Internet to a remote data store for later use by the employee or a third party. Such activity presents a data security problem for the document's owner.

Two common approaches that have been used to address this problem 1) the use of web browser extensions and 2) the use of code injection. These are both active techniques. They require active interference with web browser processes, in ways that could impact stability or performance of the application.

The code injection approach injects a Dynamic Link Library (“DLL”) into the address space of the web browser at run-time. The DLL patches code in the web browser application to divert the processing related to file upload or download into code located in the injected DLL. The code in the injected DLL can then record the occurrence of the behavior.

The code injection approach alters the vendor delivered functionality of a web browser application by patching code and possibly internal data structures within the web browser process at run time. This is an inherently dangerous thing to do to an application of any sophistication. Mistakes or miscalculations in implementation can easily result browser application crashes. In addition, security products, and in some cases the web browser application itself, may attempt to interfere with or block code injection and patching of the web browser because of the tendency of malicious code to use such techniques.

The web browser extension approach uses the facilities provided by most web browsers for writing extensions in JavaScript that can interact with web pages and the web browser itself. In this approach an extension will rewrite portions of the web page code to hook common pathways by which web applications initiate file upload or download activity.

The web extension approach requires setup that adds complexity and reduces flexibility and ease of deployment. The web extension approach requires first installing the web extension into all the supported browsers that will be monitored on the on the endpoint computers. Forcing the install of a web extension without user intervention throughout an organization will typically require the use of group policies in a Microsoft Windows environment. This requires an administrative change to the network before the solution can be effectively deployed. In addition, due to security restrictions implemented by most browsers, web extensions cannot be installed from the local disk. They must be installed over the network from a web store or a URL marked as trusted as indicated through a separate policy setting. In that case, the vendor implementing such a solution would have to publish their web extension publicly to a web store or require their customer to host it locally on their internal network. Finally, after the installation of a web extension by a policy the web extension may not take effect until the web browser application is restarted.

### SUMMARY OF VARIOUS EMBODIMENTS

Illustrative embodiments detect file uploads and downloads initiated by user activity and captures the disk file path and URL associated with the activity. This capability has various uses in the security domain. Some embodiments are useful, for example, to monitor the exfiltration of an organization's data from endpoint computers to file sharing web sites by malicious insiders.

Various embodiments employ a unique approach to address these issues by using operating system facilities to passively observe a web browser application's activity, such as process and file system activity, and applies heuristics to these behaviors to reliably detect the occurrence of user-initiated file upload and download in the web browser. Illustrative embodiments then employ user accessibility features available in the operating system in conjunction with heuristics to read the contents of the URL Bar from the web browser application's user interface at the time of the upload or download.

A first illustrative embodiment includes a method of identifying exfiltration of a file from a computer system via a web browser running under an operating system, the web browser having a URL bar. The method includes:
detecting, by a session monitor monitoring a first session running under the operating system, initiation of a file upload in a web browser running in the session by:
identifying, using native resources of the operating system and without using a web browser extension and without code injection for said identifying, a head browser process for the web browser; and
detecting, using native resources of the operating system, opening of a file via the web browser;
in response to detecting opening of the file, identifying a uniform resource locator from the web browser by:
identifying, using user accessibility features of the operating system, a window in which the web browser is displayed;
identifying the web browser using user accessibility features of the operating system, said web browser being an identified web browser;
obtaining, from a computer memory, browser heuristics associated with the identified web browser;
identifying, using the browser heuristics associated with the identified web browser, the URL bar of the identified web browser;
reading, using the session monitor, the uniform resource locator from the web browser's URL bar; and
determining that the uniform resource locator is a prohibited URL.

Some embodiments of the method further include: prior to detecting initiation of a file upload in a web browser, detecting initiation of the web browser in the first session, and spawning the session monitor in the first session.

In some embodiments of the method, determining that the uniform resource locator is a prohibited URL comprises determining that the uniform resource locator matches a URL on a list of prohibited URLs.

In some embodiments of the method, determining that the uniform resource locator is a prohibited URL comprises determining that the uniform resource locator is not on a list of allowed URLs.

Some embodiments of the method further include: in response to determining that the uniform resource locator is a prohibited URL: preventing the upload.

Some embodiments of the method further include: in response to determining that the uniform resource locator is a prohibited URL: causing the computer system to take a screenshot of the web browser.

Some embodiments of the method further include: in response to determining that the uniform resource locator is a prohibited URL: alerting an administrator of the computer system.

Some embodiments of the method further include: in response to determining that the uniform resource locator is a prohibited URL: causing the computer system to take a screenshot of the web browser; and alerting an administrator of the computer system by sending the screenshot that administrator.

Some embodiments of the method further include: detecting initiation of a session on the computer system and, in response to said detecting, spawning the session monitor within the session.

In some embodiments of the method, the method identifies exfiltration of a file from a computer system via a web browser running under an operating system without injecting a Dynamic Link Library (“DLL”) into the address space of the web browser at run-time.

In some embodiments, the method identifies exfiltration of a file from a computer system via a web browser running under an operating system without installing a web browser extension into the web browser, which web browser extension is configured to interact with web pages and the web browser itself to rewrite portions of web page code to capture a pathway by which the web browser initiates file upload activity.

Yet another embodiments includes a computer-implemented system for identifying exfiltration of a file, the system including:
a computer system having a web browser running under an operating system, the web browser having a URL bar;
a session monitor configured to detect initiation of a file upload in the web browser running in a session by:
identifying, using resources of the operating system, a head browser process for the web browser; and
detecting, using resources of the operating system, opening of a file via the web browser;
an identifying module configured to identify, in response to detecting opening of the file by the session monitor, a uniform resource locator from the web browser by:
identifying, using user accessibility features of the operating system, a window in which the web browser is displayed;
identifying the web browser using user accessibility features of the operating system;
obtaining, from a computer memory, browser heuristics associated with the web browser;
identifying, using the browser heuristics associated with the web browser, the URL bar of the web browser;
the session monitor further configured to read the uniform resource locator from the web browser's URL bar; and
a determination module configured to determine whether the uniform resource locator is a prohibited URL.

In some embodiments, the determination module is configured to determine whether the uniform resource locator is a prohibited URL by determining that the uniform resource locator matches a URL on a list of prohibited URLs.

In some embodiments, the determination module is configured to determine whether the uniform resource locator is a prohibited URL by determining whether the uniform resource locator is not on a list of allowed URLs.

Some embodiments of the system further include a prevention module configured to prevent upload of the file in response to a determination, by the determination module, that the uniform resource locator is a prohibited URL.

Some embodiments of the system further include an evidence module configured to take a screenshot of the web browser in response to a determination, by the determination module, that the uniform resource locator is a prohibited URL.

Some embodiments of the system further include an alert module configured to alert an administrator of a computer system in response to a determination, by the determination module, that the uniform resource locator is a prohibited URL.

Some embodiments of the system further include a spawning module configured to detect initiation of a session on the computer system and, in response to said detection, to spawn the session monitor within the session.

Yet another embodiment includes a non-transitory computer-readable medium having computer executable code thereon, the computer executable code, when executed by a computer system, causing the computer system to perform a method, the code including: code for detecting, by a session monitor monitoring a session, initiation of a file upload in a web browser running in the session by:
identifying, using resources of the operating system, a head browser process for the web browser; and
detecting, using resources of the operating system, opening of a file via the web browser;
code for identifying, in response to detecting opening of the file, a uniform resource locator from the web browser by:
identifying, using user accessibility features of the operating system, a window in which the web browser is displayed;
identifying the web browser using user accessibility features of the operating system;
obtaining, from a computer memory, browser heuristics associated with the web browser;
code for identifying, using the browser heuristics associated with the web browser, the URL bar of the web browser;
code for reading, using the session monitor, the uniform resource locator from the web browser's URL bar; and
code for determining that the uniform resource locator is a prohibited URL.

In some embodiments, code for determining that the uniform resource locator is a prohibited URL includes: code for determining that the uniform resource locator is on a list of prohibited URLs.

In some embodiments, code for determining that the uniform resource locator is a prohibited URL includes: code for determining that the uniform resource locator is not on a list of permitted URLs.

In some embodiments, the code further includes: code for preventing upload of the file in response to determining that the uniform resource locator is a prohibited URL.

In some embodiments, the code further includes: code for causing the computer system to take a screenshot of the web browser in response to determining that the uniform resource locator is a prohibited URL; and code for alerting an administrator of the computer system by sending the screenshot to that administrator.

In some embodiments, the computer executable code does not include: a web browser extension installed in the web browser, which web browser extension is configured to interact with web pages and the web browser itself to rewrite portions of web page code to capture a pathway by which the web browser initiates file upload activity; and does not include: a Dynamic Link Library (“DLL”) disposed into the address space of the web browser at run-time.

### BRIEF DESCRIPTION OF THE DRAWINGS

The foregoing features of embodiments will be more readily understood by reference to the following detailed description, taken with reference to the accompanying drawings, in which:

FIG. 1A schematically illustrates a user's computer according to an illustrative embodiment;

FIG. 1B schematically illustrates an embodiment of a computer network;

FIG. 2A schematically illustrates an embodiment of a system;

FIG. 2B schematically illustrates an embodiment of a system;

FIG. 3 is a flowchart of an embodiment of a method for identifying prohibited file operations on a computer system;

FIG. 4 is a flowchart of an embodiment of a method for identifying prohibited file operations on a computer system;

FIG. 5 schematically illustrates an embodiment of Process Explorer data for the various Google Chrome web browser processes that are spawned upon starting the Google Chrome web browser application on a Windows operating system;

FIG. 6 schematically illustrates an embodiment of a hierarchy of user interface elements in the Google Chrome browser window;

FIG. 7 schematically illustrates an embodiment of a hierarchy of user interface elements in Mozilla Firefox.

### DETAILED DESCRIPTION OF ILLUSTRATIVE EMBODIMENTS

Illustrative embodiments provide improved computer system security against exfiltration of electronic files (e.g., documents) from the computer system to an external location, and/or download of electronic files to the computer system from an external source.

Such exfiltration is a problem that arises only in computer systems.

Advantages of embodiment that employ a passive observation approach over the typical active monitoring approaches (e.g., approaches that use a browser extension or code injection) include improved run-time stability, reduced coupling with third party applications, and ease of deployment.

In contrast to conventional approaches, the risk of causing instability in the web browser application through this passive monitoring is essentially non-existent. The passive observation approach does not actively interfere with or alter the vendor delivered functionality of the web browser application at run time. It uses using operating system facilities and programming interfaces in their intended and supported fashion to monitor interactions between the operating system web browser application.

In comparison to conventional approaches, the passive observation approach is system-centric. It relies on capabilities and interfaces provided by the operating system, not third-party applications. While the passive observation approach requires knowledge of the web browsers interaction with the operating system, it does not require internal implementation details. The core algorithms employed in this approach do not change between different web browser applications, instead only the specific heuristics used in those algorithms change. In addition, an expected use case for various embodiments is endpoint security products. These products already make heavy use of operating system facilities such as kernel modules for process and file system activity monitoring. Implementing various embodiments in such applications leverages existing capabilities and developer knowledge without introducing dependencies on additional programming interfaces or languages such as JavaScript.

Definitions: As used in this description and the accompanying claims, the following terms shall have the meanings indicated, unless the context otherwise requires.

An “event record” (sometimes referred-to simply as an “event”) is a record of process of a user-initiated file upload or a user-initiated file download.

A “module” includes computer system hardware under control of computer-executable code which code, when executed by computer system hardware, causes the computer system to perform the functionality of the associated module. A module may be configured to perform functionality by providing to a computer system computer-executable code which code, when executed by the computer system, causes the computer system to perform the functionality.

The term “real time” with regard to activity detection means operations that occur while an activity is taking place, as opposed to after the activity has taken place, for example by assessing log data.

With regard to detecting and preventing exfiltration of a file from a computer system to another computer system (e.g., a remote computer system), the term “real time” means detecting an initiated exfiltration, and preventing completion of said exfiltration of said file before the file can be exfiltrated from the computer system.

With regard to detecting and preventing download of a file to a computer system from another computer system (e.g., a remote computer system), the term “real time” means detecting an initiated download and preventing completion of said download before the file can be downloaded to the computer system.

A “set” includes at least one member.

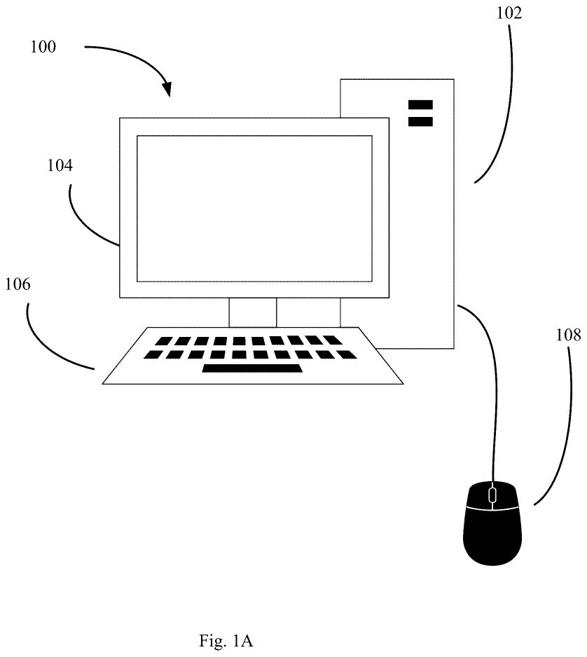

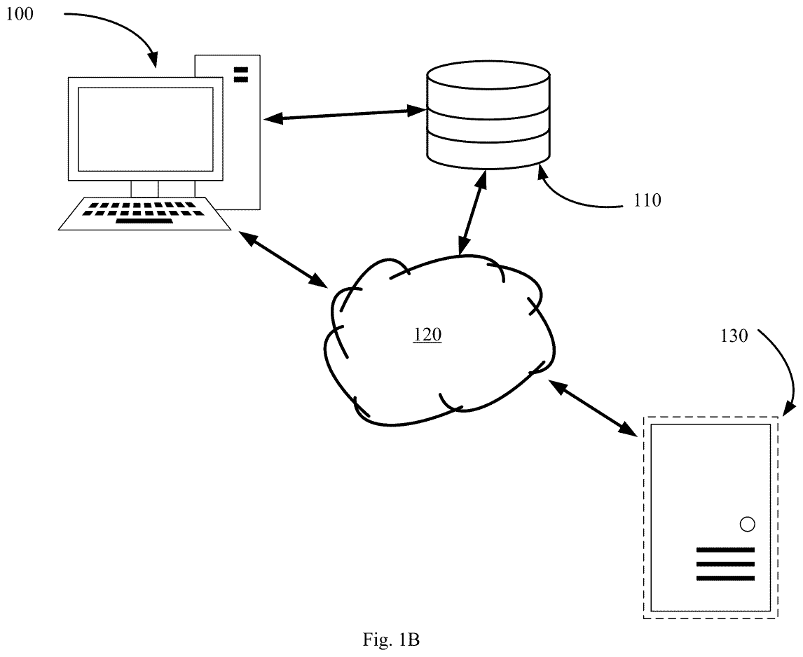

FIG. 1A schematically illustrates a user's computer 100 according to an illustrative embodiment. The computer 100 includes a central processing unit 102, a computer monitor (or computer display) 104, a computer keyboard 106, and a computer mouse 108. The computer 100 includes an operating system, and a web browser operating under the operating system.

FIG. 1B schematically illustrates an embodiment of a computer network 110, which includes a user's computer 100 and a remote computer 130. The user's computer 100 is in communication with the remote computer 130 over a network 120. The network 120 may be the Internet or a wide area network, for example.

A user of the user's computer 100 could upload (e.g., exfiltrate) an electronic file from the user's computer, or from a company network to which the user's computer 100 is coupled, to the remote computer 130 over the network 120.

A user of the user's computer 100 could download an electronic file from the remote computer system 130 to the user's computer 100 over the network 120.

Illustrative embodiments detect file uploads and/or file downloads initiated by user activity through a web browser application and captures the disk file path and URL associated with the activity. This capability has various uses in the security domain. One particular use case motivating present embodiments is the need to monitor the exfiltration of an organization's data from endpoint computers to file sharing web sites by malicious insiders.

Illustrative embodiments employ a unique approach to solve this problem. It uses operating system facilities to passively observe a web browser application's activity, such as process and file system activity, and applies heuristics to these behaviors to reliably detect the occurrence of user-initiated file upload and download in the web browser. It then employs user accessibility features available in the operating system in conjunction with heuristics to read the contents of the URL Bar from the web browser application's user interface at the time of the upload or download. This approach contrasts with the typical approaches used to solve this problem which are invasive and interfere with the web browser's functionality in ways that could impact stability or performance of the application.

Modern web browser applications employ an architecture based on the security principles of separation of duties and least privilege. The work of the various subsystems of the web browser application is divided at run-time between a myriad of separate, cooperating processes. These separate processes carry out different functions and are assigned varying levels of trust within the operating system. Under this architecture, when the web browser application starts, a head browser process is created. It then creates multiple other browser processes. Every process associated with the web browser application executes the same image on disk, but the processes are executed with different command line options to assign them their distinct roles.

The head browser process is the process that provides the graphical user interface for the web browser application. It is also the process that performs much of the file system activity associated with user-initiated file uploads and downloads in the web browser application. By applying heuristics to the command line options that were used to start the various web browser processes illustrative embodiments can uniquely identify the head browser process from amongst the other web browser processes. Once illustrative embodiments have identified the head browser process, such embodiments monitor file system activity of the head browser process and apply heuristics to identify the occurrence of user-initiated file uploads and/or downloads. When the user initiates a file upload, the head browser process opens the file for uploading. The combination of options used in the operating system application programming interface (“API”) to open the file in conjunction with the file path provide the basis for heuristics used by illustrative embodiments to determine when the web browser is attempting to upload a file. The specific heuristics differ slightly between different web browser applications.

When the user initiates a file download, the web browser application first downloads the file to a temporary location on disk. Once the web browser application finishes downloading the file to the temporary file, the head browser process renames the temporary file to the downloaded file name. The extension used for the temporary file name is consistent, and the use of that extension in file rename operations performed by the head browser process is unique to renaming downloaded files. By identifying file rename operations performed by the head browser process where the source file to be renamed has the known extension, illustrative embodiments can identify the completion of a user-initiated file download operation as well as the identify the full storage path for the downloaded file. The heuristics associated with the file rename operation differ between different web browser applications.

Once illustrative embodiments have identified the occurrence of file upload or download activity, illustrative embodiments identify the URL associated with the activity. To do this, illustrative embodiments employ user accessibility facilities provided by the operating system. These facilities are often used for applications such as assisted screen reading. They provide run-time support for interrogating the user interface elements contained in an application window. Common user interface elements include edit boxes, buttons, menu items, tool bars, and panes. These user interface elements are arranged in a hierarchy within a window, and each element has an associated type and may have an assigned name. Illustrative embodiments search through the web browser application's user interface, which is hosted by the head browser process, to find and copy the contents of user interface element corresponding to the web browser's URL bar. The web browser's URL bar contains the URL associated with the active browser tab. Each browser application is slightly different in terms of the hierarchical layout of user interface elements and the names or identifiers associated with the elements in use, so the heuristics for finding the URL bar differ between browser applications.

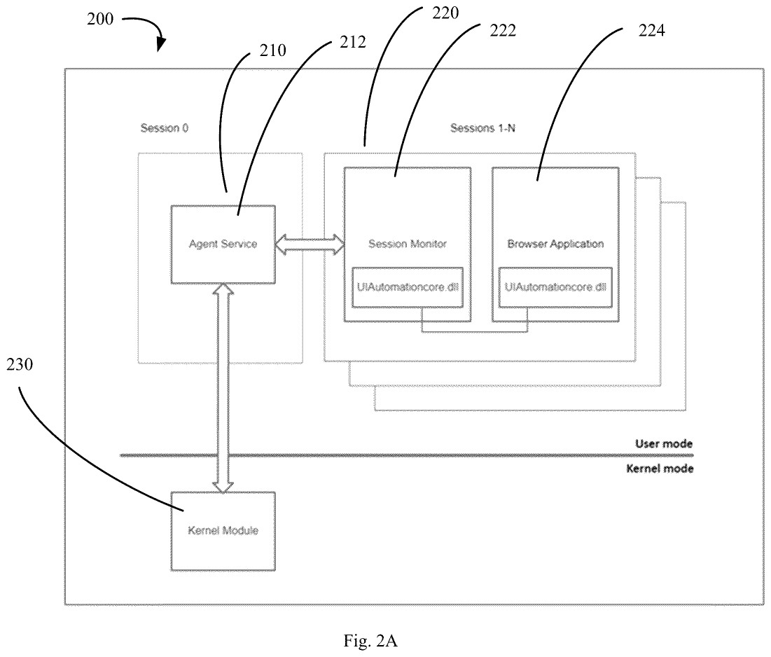

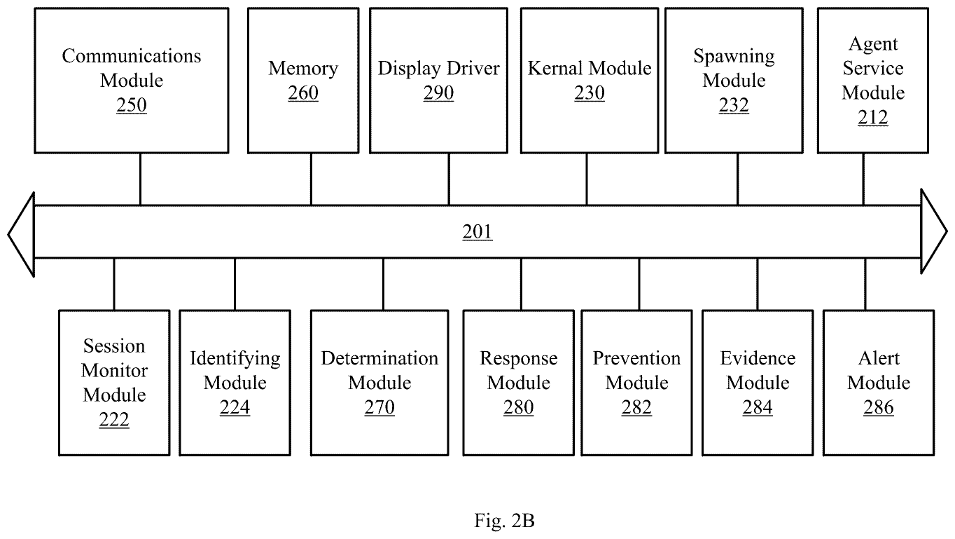

FIG. 2A schematically illustrates an embodiment of a system 200. The system 200 may be implemented, in whole or in part, on a computer 100 or a plurality of computers in a network.

The inventors implemented several embodiments in the Windows operating system and supports the following web browser applications: Google Chrome, Microsoft Edge, and Mozilla Firefox. The implementation consists of a kernel module 230, a user space service referred to as the Agent Service, and a user session executable referred to as the Session Monitor. FIG. 2A illustrates the relationship between these components.

The kernel module 230 monitors process activity and file system activity on the system. It generates event data in response to these activities. The Agent Service 212 uses device I/O control requests to obtain the event data from the kernel module. The Agent Service 212 applies heuristics to event data to identify file occurrence of file upload and download activity in a web browser application.

In response to file upload and download activity, the Agent Service 212 coordinates the work to obtain the URL associated with the activity. This is obtained by reading the URL bar contents from the web browser's user interface. However, the Agent Service 212 runs in session 0 (session zero), and operating system security policies prevent it from interacting with the user interfaces of applications running in other user sessions. So, the Agent Service 212 relies on a Session Monitor 222 which is executed inside the individual user sessions to perform the required interaction with the web browser application's user interface. The Agent Service 212 monitors user logon activity on the endpoint and in response to new logons spawns a Session Monitor 222 executable inside that user session. The Agent Service 212 communicates requests to Session Monitor 222 instances using a named pipe.

In some embodiments, the Session Monitor 222 uses Microsoft's UI Automation framework to interrogate the user interfaces of web browser applications. The UIAutomationcore.dll module supplied by the Windows operating system provides the support for this interaction. The operation of these components is described in greater detail below.

The kernel module 230 uses operating system APIs to receive notifications when processes start and exit on the system. The kernel module 230 also registers as a file system mini-filter driver to monitor when files are opened and when files are renamed. In response to these activities the kernel module 230 generates a set of structured data packets, referred to as events, that detail the activity.

A process event includes the related process ID, an indication of whether the process started or exited, the full executable path, as well as the full command line used to start the process. A file event includes the process ID of the process that performed the file operation, the type of operation, either open or rename, and the related file path data. In the case of file opens, the event data specifies the full file path that was opened. In the case of rename operations the event data includes the full path of both the source and destination file names.

The Agent Service 212 consumes the events generated by the kernel module 230. To address the scenario in which a browser application may have started prior to the loading of the kernel module 230, the Agent Service 212 also enumerates all existing processes at the time it starts and creates process events in response to them.

In response to a process start event the Agent Service 212 applies heuristics for identifying the head browser process. The heuristics used for identifying the head browser process are based on command line options and differ between browser applications. At a minimum the executable path is checked for the expected executable name of “chrome. exe”, “firefox. exe”, or “msedge. exe”. Additional checks beyond the executable name can be performed to verify the application's provenance, such as examining the certificate information with which the application was signed. In current versions of Google Chrome and Microsoft Edge, the absence of the string “-type=” within the command line options reliably signifies the head browser process. In current versions of Mozilla Firefox absence of the string “-contentproc” signifies the head browser process.

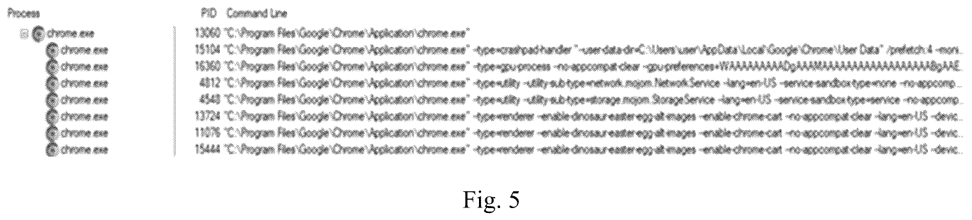

These heuristics are developed using tools like the SysInternals Process Explorer tool. FIG. 5 shows Process Explorer data for the various Google Chrome web browser processes that are spawned upon starting the Google Chrome web browser application on Windows. The first process shown, PID 13060, is the head browser process.

In response to a file event, the Agent Service 212 checks if the process ID associated with the file event matches a head browser process ID. If a matching file event represents a file open, illustrative embodiments check the parameters to the file open system call such as desired access, share mode, creation disposition against a heuristic. Portions of the opened file path are also checked against an exclusionary path filter to reduce the risk of false positives. This is because the head browser process may sometimes open certain of its own application data files using the same file parameters used to open files for uploads. These cases typically involve files located in paths associated with the web browser's installation location or data directories, and illustrative embodiment can enumerate them through testing.

In circumstances in which a matching file event represents a file rename, illustrative embodiments check the extension of the source file being renamed against heuristics. The extensions used for in-progress file downloads vary between browsers. Microsoft Edge and Google Chrome use the extensions “.crdownload” while Mozilla Firefox uses “.part”. Portions of the destination file path are also checked against an exclusionary path filter to reduce the risk of false positives. This is because there are cases in which download operations initiated by the web browser, for example during software update operations, may employ this same download technique as user-initiated downloads. These cases typically involve files being saved in path locations associated with the web browser's installation location or data directories, and illustrative embodiments can enumerate them through testing.

After detecting a user-initiated file upload or download operation, illustrative embodiments determine the URL associated with the activity by using the Windows UI Automation framework (see, e.g., Karl-Bridge-Microsoft, “IUIAutomation (uiautomationclient. h)—Win32 Apps,” Microsoft Learn, Oct. 5, 2021, https://learn.microsoft.com/en-us/windows/win32/api/uiautomationclient/nn-uiautomationclient-iuiautomation.). Illustrative embodiments use this framework to programmatically search the hierarchy of user interface elements in the user interface of the head browser process to obtain the contents of the URL Bar. The Agent Service 212 initiates this work by sending a command over named pipe communications to the Session Monitor 222 with the process ID of the head browser process. The Session Monitor 222 uses a series of heuristics to find the window associated with the web browser application and then to read the contents of its URL bar.

First, the Session Monitor 222 determines the name of the web browser application executable based on the process ID for the head browser process by using the GetProcessImageFileName API. Based on knowing which web browser application is in use, the Session Monitor 222 selects the heuristic for the web browser's window class name. For both Google Chrome and Microsoft Edge, the window class is “Chrome_WidgetWin_1”. In the case of Mozilla Firefox, the Window class name is “MozillaWindowClass”.

Next the FindWindowsEx API is repeatedly called to return a handle for every instance of a window on the system using the expected class name. For each window instance found, the Session Monitor 222 calls the IsWindowVisible function to determine whether this window has the visible property. A web browser application may have several windows, some of which do not have the visible property. The visible property indicates that this window is allowed to be displayed on the screen. A window can be marked as hidden and effectively invisible on screen. The window containing the URL bar will always have the visible property.

Then the Session Monitor 222 uses the GetWindowThreadProcessId API to check whether the window handle is owned by the head browser process based on the process ID supplied to the Session Monitor 222 by the Agent Service 212. This is important because there may be multiple window instances in a user session using the same window class name. For example, Microsoft Edge and Google Chrome are both based on the open-source Chromium web browser, and consequently both use the same window class name of “Chrome_WidgetWin_1”. It is possible the Chromium web browser may be incorporated into other applications as well.

Finally, there may be multiple windows owned by the head browser process that meet all the above criteria. This occurs for example when multiple windows are opened in a web browser application. Because the FindWindowEx API returns window handles in Z-order (see., e.g., Wikipedia contributors, “Z-order,” Wikipedia, Feb. 13, 2024, https://en.wikipedia.org/wiki/Z-order.), the last window handle returned which matches all our criteria is the topmost of the matching browser windows. Because the user is actively interacting with the browser interface at the time illustrative embodiments detect the file upload or download activity, this topmost window is the correct window to interrogate.

Once a handle to the appropriate window has been obtained, the Microsoft Windows Automation API can be used to search the user interface elements within the window to find the URL bar.

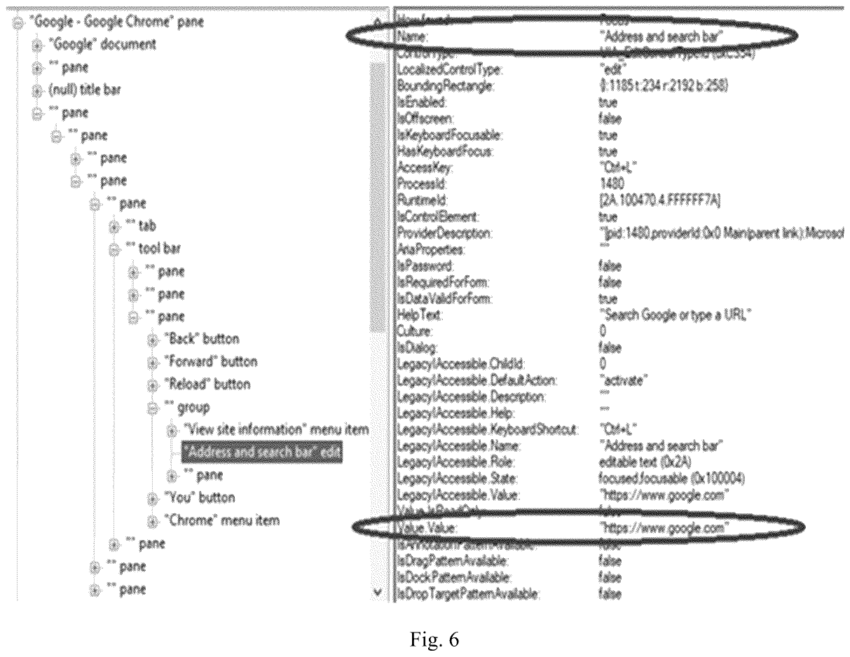

FIG. 6 shows the hierarchy of user interface elements in the Google Chrome browser window as displayed by Microsoft's Inspect tool (see, e.g., Karl-Bridge-Microsoft, “Accessibility Tools-Inspect-Win32 Apps,” Microsoft Learn, Feb. 10, 2023, https://learn.microsoft.com/en-us/windows/win32/winauto/inspect-objects.). The selected element has a type of “edit”, indicating an edit control box, and a name of “Address and search bar”. The right-hand side shows the name associated with the element that illustrative embodiments use in the Automation API to search for it. The value contained within this element corresponds with the URL string displayed in the web browser's URL bar. This is the URL associated with the active browser tab.

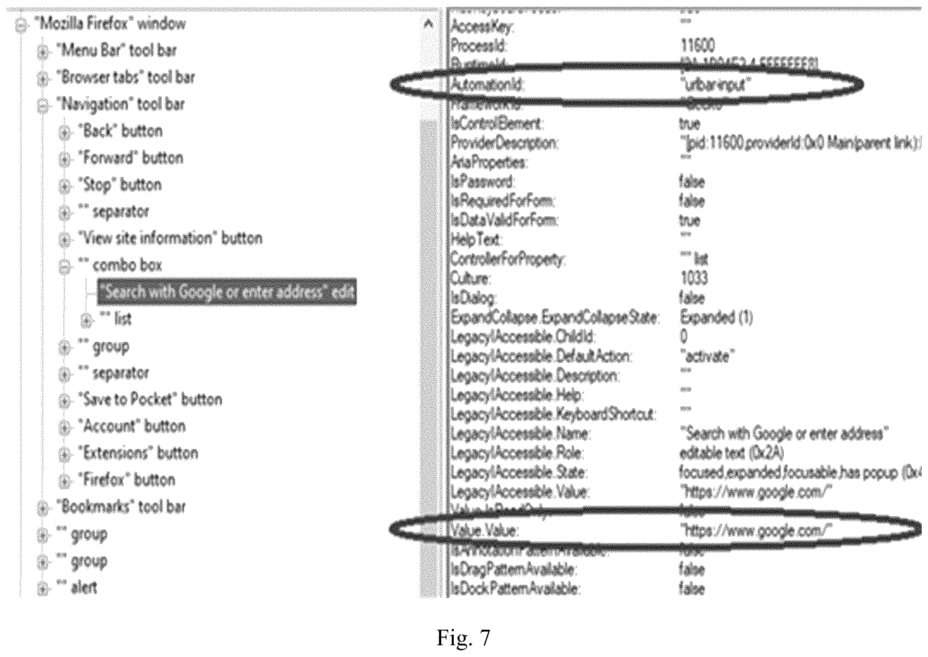

FIG. 7 shows the hierarchy of user interface elements in Mozilla Firefox. In this case the URL bar element has a name associated with it that changes based on the default search engine configured for the browser. Because that value may be changed according to user configuration, illustrative embodiments instead rely on the automation ID associated with this element in our search heuristics.

FIG. 2B schematically illustrates an embodiment of a system.

The system includes an interface 201 configured to enable communication from each module of the system to each other module of the system.

The system includes a communications module 250 configured to enable electronic communication between the system and other electronic systems such as computers, databases, or memories.

The system includes a memory 260 configured to store code for execution by the system, and/or data.

The system includes a display driver 290 configured to generate a visual display on a computer monitor 104.

The system includes a spawning module 232, which in some embodiments may be included in Kernel module 230, configured to detect initiation of a session on the computer system and, in response to said detection, to spawn the session monitor within the session.

The system includes a session monitor module 222 configured to detect initiation of a file upload in the web browser running in a session by: identifying, using resources of the operating system, a head browser process for the web browser; and detecting, using resources of the operating system, opening of a file via the web browser.

The system includes an identifying module 224, which may be included in session monitor 222, configured to identify, in response to detecting opening of the file by the session monitor, a uniform resource locator from the web browser. In some embodiments, the identifying module 224 is configured to identify, in response to detecting opening of the file by the session monitor, a uniform resource locator from the web browser by: identifying, using user accessibility features of the operating system, a window in which the web browser is displayed; identifying the web browser using user accessibility features of the operating system; obtaining, from a computer memory, browser heuristics associated with the web browser; and identifying, using the browser heuristics associated with the web browser, the URL bar of the web browser. In some embodiments, the identifying module is configured to read the URL from the URL bar.

The system includes a determination module 270 configured to determine whether the uniform resource locator is a prohibited URL. In some embodiments, the determination module 270 is configured to determine whether the uniform resource locator is a prohibited URL by determining that the uniform resource locator matches a URL on a list of prohibited URLs. In some embodiments, determination module 270 is configured to determine whether the uniform resource locator is a prohibited URL by determining whether the uniform resource locator is not on a list of allowed URLs.

The system also includes a response module 280 configured to initiate or execute one or more responses to detecting initiation of a download of a file from a prohibited URL, and/or initiate of an upload of a file from a prohibited URL.

The system includes a prevention module 282, which in some embodiments may be included in response module 280, configured to prevent upload of the file in response to a determination, by the determination module, that the uniform resource locator is a prohibited URL.

The system includes an evidence module 284, which in some embodiments may be included in response module 280, configured to take a screenshot of the web browser in response to a determination, by the determination module, that the uniform resource locator is a prohibited URL.

The system includes an alert module 286, which in some embodiments may be included in response module 280, configured to alert an administrator of a computer system in response to a determination, by the determination module, that the uniform resource locator is a prohibited URL.

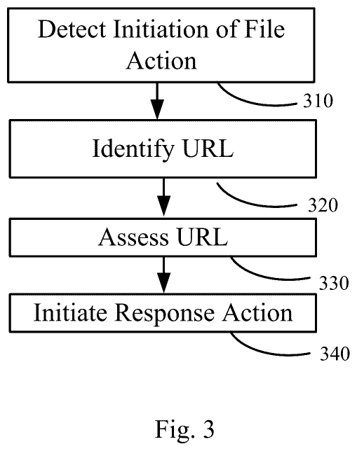

FIG. 3 is a flowchart of an embodiment of method of detecting and reacting to initiation of a file upload to a remote computer system, or file download from a remote computer system, via a web browser on a user's computer system.

Step 310 includes detecting initiation of a file upload from a user's computer 100 to remote computer system 130 over a network 120 via a web browser. Such a file may be referred-to as a “target” file.

Such a file upload may be initiated, for example, by a user of the web browser on the user's computer 100. In illustrative embodiments, the initiated upload is part of uploading a file from the user's computer 100 to the remote computer system 130, wherein the remote computer system 130 is identified by a unique uniform resource locator (or “URL”). Such a URL may be referred-to as the “target” URL. In illustrative embodiments, the user of the user's computer 100 may be described as an “insider” in that the user is authorized to use that computer 100, and maybe authorized to access the file being uploaded, and may be authorized to access a company network with which the user's computer is in communication. Use of the computer 100, and/or access by the user to the file, and/or access by the user to a company network, typically would not trigger an alert of unauthorized user or access. Such use and/or access would not be an intrusion into the computer 100 or a company network with which the computer 100 is in communication, and therefore would not be detected as an intrusion and would trigger an intrusion alert.

Step 320 includes identifying the target URL. A URL identified at step 320 may be referred-to as an “identified” URL.

Step 330 includes assessing the detected upload activity. In some embodiments, step 330 includes comparing the identified URL against a set of prohibited URLs to determine whether the initiated upload is attempting to, or intended to, upload the file to a URL or computer system to which such uploads are prohibited. Such a set of prohibited URLs may be defined, for example, by the owner of the target file.

In some embodiments, determining that the uniform resource locator is a prohibited URL includes determining that the uniform resource locator matches a URL on a list of prohibited URLs.

In some embodiments, determining that the uniform resource locator is a prohibited URL includes determining that the uniform resource locator is not on a list of allowed URLs.

Step 340 includes taking action to secure the file (and thereby, for example, securing a company's data) in response to detecting upload activity to the identified URL. The action may include preventing successful completion of a detected upload by, for example, terminating or freezing the operation of the web browser, and/or terminating the web browser on the user's computer 100, to name but a few examples.

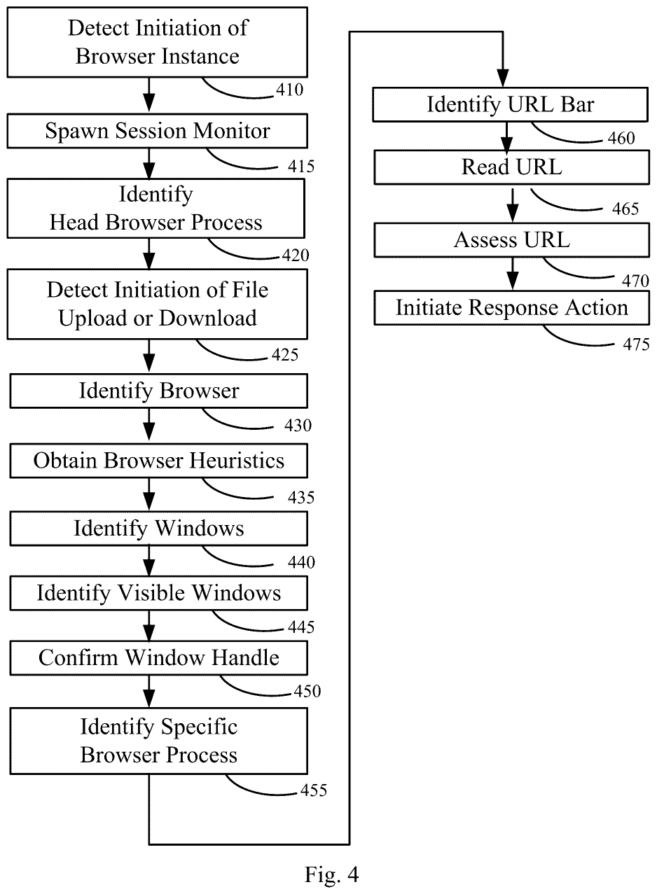

FIG. 4 is a flowchart of a method of preparing a computer 100 to implement embodiments described herein.

Step 410 includes detecting initiation of a browser instance on a user's computer system.

Step 415 includes spawning a session monitor (e.g., an instance of a session monitor module 222).

Step 420 includes identifying a head browser process for the detected browser instance.

Step 425 includes detecting a file action from the detected browser. A file action may include initiation of a file upload to a URL from the user's computer system via the browser, and/or initiation from within the browser of a file download to the user's computer system.

Step 430 includes identifying the browser type associated with the file action. For example, a browser type may be Google Chrome, Firefox, or Microsoft Edge, to name but a few examples.

Step 435 includes obtaining or accessing a set of browser heuristics, which browser heuristics are associated with the identified browser type. In illustrative embodiments, an associated (or “corresponding”) set of heuristics may be stored in, and accessible from, a computer's memory, and/or a remote computer or database 110 accessible from the computer 100 directly, or over network 120.

The process also identifies the window in which the identified browser is operating. To that end, step 440 includes identifying windows running on the user's computer system. Step 445 includes identifying, from the windows identified at step 440, which of the identified windows is visible.

Step 450 includes confirming the window handle.

Step 455 includes identifying a specific browser process.

The process also includes identifying the URL associated with the file action in the identified browser (an embodiment of step 320 from FIG. 3). To that end, step 460 includes identifying the URL bar within the identified browser, and step 465 includes reading the URL from the URL bar.

Step 470 includes assessing the URL to determine whether the URL is a prohibited URL (e.g., an embodiment of step 330 from FIG. 3). A prohibited URL is a URL to which file upload and/or from which file download is prohibited by a policy applicable to the user's computer system.

Step 475 (e.g., an embodiment of step 340 from FIG. 3) includes initiating a response action when a file action includes a file upload to a prohibited URL and/or file download from a prohibited URL. A response action may include, for example, one or more of the following: preventing the file action (e.g., preventing the upload; preventing the download); causing the computer system to take a screenshot of the web browser; and/or alerting an administrator of the computer system; and/or causing the computer system to take a screenshot of the web browser; and alerting an administrator of the computer system by sending the screenshot that administrator.

A listing of certain reference numbers is presented below.
100: User's computer system;
102: Central processing unit;
104: Computer display monitor;
106: Computer Keyboard;
108: Computer mouse;
110: Database;
120: Computer network;
130: Remote computer;
200: System;
201: Communications interface;
210: Session zero;
212: Agent Service (or Agent Service Module);
220: Session One;
222: Session Monitor (or Session Monitor Module);
224: Browser Application;
230: Kernal Module;
250: Communications Module;
260: Memory Module;
270: Determination Module;
280: Response Module;
290: Display Driver Module;

Various embodiments may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Without limitation, potential subject matter that may be claimed (prefaced with the letter “P” so as to avoid confusion with the actual claims presented below) includes:
P1. A method of identifying exfiltration of a file from a computer system via a web browser running under an operating system, the web browser having a URL bar, the method comprising:
detecting, by a session monitor monitoring a session, initiation of a file upload in a web browser running in the session by:
identifying, using native resources of the operating system, a head browser process for the web browser; and
detecting, using native resources of the operating system, opening of a file via the web browser;
in response to detecting opening of the file, identifying a uniform resource locator from the web browser by:
identifying, using user accessibility features of the operating system, a window in which the web browser is displayed;
identifying the web browser using user accessibility features of the operating system, said web browser being an identified web browser;
obtaining, from a computer memory, browser heuristics associated with the identified web browser;
identifying, using the browser heuristics associated with the identified web browser, the URL bar of the identified web browser;
reading, using the session monitor, the uniform resource locator from the web browser's URL bar; and
determining that the uniform resource locator is a prohibited URL.
P2. The method of P1, wherein determining that the uniform resource locator is a prohibited URL comprises determining that the uniform resource locator matches a URL on a list of prohibited URLs.
P3. The method of P1, wherein determining that the uniform resource locator is a prohibited URL comprises determining that the uniform resource locator is not on a list of allowed URLs.
P4. The method of any of P1-P3, further comprising: in response to determining that the uniform resource locator is a prohibited URL: preventing the upload.
P5. The method of any of P1-P4, further comprising: in response to determining that the uniform resource locator is a prohibited URL: causing the computer system to take a screenshot of the web browser.
P6 The method of any of P1-P5, further comprising: in response to determining that the uniform resource locator is a prohibited URL: alerting an administrator of the computer system.
P7. The method of any of P1-P6, further comprising: in response to determining that the uniform resource locator is a prohibited URL: causing the computer system to take a screenshot of the web browser; and alerting an administrator of the computer system by sending the screenshot that administrator.
P8. The method of any of P1-P7, further comprising:
detecting initiation of a session on the computer system and, in response to said detecting, spawning the session monitor within the session.
P9. The method of any of P1-P8, wherein the method identifies exfiltration of a file from a computer system via a web browser running under an operating system without the use of a web browser extension and without the use of code injection.
P10. The method of any of P1-P9, wherein the method identifies exfiltration of a file from a computer system via a web browser running under an operating system without injecting a Dynamic Link Library (“DLL”) into the address space of the web browser at run-time.
P11. The method of any of P1-P10, wherein the method identifies exfiltration of a file from a computer system via a web browser running under an operating system without installing a web browser extension into the web browser, which web browser extension is configured to interact with web pages and the web browser itself to rewrite portions of web page code to capture a pathway by which the web browser initiates file upload activity.
P112. A computer-implemented system for identifying exfiltration of a file, the system comprising:
a computer system having a web browser running under an operating system, the web browser having a URL bar;
a session monitor configured to detect initiation of a file upload in the web browser running in a session by:
identifying, using resources of the operating system, a head browser process for the web browser; and
detecting, using resources of the operating system, opening of a file via the web browser;
an identifying module configured to identify, in response to detecting opening of the file by the session monitor, a uniform resource locator from the web browser by:
identifying, using user accessibility features of the operating system, a window in which the web browser is displayed;
identifying the web browser using user accessibility features of the operating system;
obtaining, from a computer memory, browser heuristics associated with the web browser;
identifying, using the browser heuristics associated with the web browser, the URL bar of the web browser;
the session monitor further configured to read the uniform resource locator from the web browser's URL bar; and
a determination module configured to determine whether the uniform resource locator is a prohibited URL.
P113. The system of P112 wherein the determination module is configured to determine whether the uniform resource locator is a prohibited URL by determining that the uniform resource locator matches a URL on a list of prohibited URLs.
P114. The system of any of P112-P113 wherein the determination module is configured to determine whether the uniform resource locator is a prohibited URL by determining whether the uniform resource locator is not on a list of allowed URLs.
P115. The system of any of P112-P114, further comprising a prevention module configured to prevent upload of the file in response to a determination, by the determination module, that the uniform resource locator is a prohibited URL.
P116. The system of any of P112-P115, further comprising an evidence module configured to take a screenshot of the web browser in response to a determination, by the determination module, that the uniform resource locator is a prohibited URL.

P117. The system of any of P112-P116 further comprising an alert module configured to alert an administrator of a computer system in response to a determination, by the determination module, that the uniform resource locator is a prohibited URL.
P118. The system of any of P112-P117 further comprising a spawning module configured to detect initiation of a session on the computer system and, in response to said detection, to spawn the session monitor within the session.
P219. A non-transitory computer-readable medium having computer executable code thereon, the computer executable code, when executed by a computer system, causing the computer system to perform a method, the code comprising:
code for detecting, by a session monitor monitoring a session, initiation of a file upload in a web browser running in the session by:
identifying, using resources of the operating system, a head browser process for the web browser; and
detecting, using resources of the operating system, opening of a file via the web browser;
code for identifying, in response to detecting opening of the file, a uniform resource locator from the web browser by:
identifying, using user accessibility features of the operating system, a window in which the web browser is displayed;
identifying the web browser using user accessibility features of the operating system;
obtaining, from a computer memory, browser heuristics associated with the web browser;
code for identifying, using the browser heuristics associated with the web browser, the URL bar of the web browser;
code for reading, using the session monitor, the uniform resource locator from the web browser's URL bar; and
code for determining that the uniform resource locator is a prohibited URL.
P220. The non-transitory computer-readable medium of P219, wherein code for determining that the uniform resource locator is a prohibited URL comprises: code for determining that the uniform resource locator is on a list of prohibited URLs.
P221. The non-transitory computer-readable medium of any of P219-P220,wherein code for determining that the uniform resource locator is a prohibited URL comprises:
code for determining that the uniform resource locator is not on a list of permitted URLs.
P222. The non-transitory computer-readable medium of any of P219-P221,further comprising code for preventing upload of the file in response to determining that the uniform resource locator is a prohibited URL.
P223. The non-transitory computer-readable medium of any of P219-P222,further comprising:
code for causing the computer system to take a screenshot of the web browser in response to determining that the uniform resource locator is a prohibited URL; and code for alerting an administrator of the computer system by sending the screenshot to that administrator.
P224. The non-transitory computer-readable medium of any of P219-P223,wherein the computer executable code does not comprise:
a web browser extension installed in the web browser, which web browser extension is configured to interact with web pages and the web browser itself to rewrite portions of web page code to capture a pathway by which the web browser initiates file upload activity.
P225. The non-transitory computer-readable medium of any of P219-P224,wherein the computer executable code does not comprise:
a Dynamic Link Library (“DLL”) disposed into the address space of the web browser at run-time.
P301. A non-transitory computer-readable medium having computer executable code thereon, the computer executable code, when executed by a computer system, causing the computer system to perform a method of any of P1-P11.

Various embodiments of this disclosure may be implemented at least in part in any conventional computer programming language. For example, some embodiments may be implemented in a procedural programming language (e.g., “C”), or in an object-oriented programming language (e.g., “C++”), or in Python, R, Java, LISP or Prolog. Other embodiments of this disclosure may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a non-transitory computer readable medium (e.g., a diskette, CD-ROM, ROM, FLASH memory, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of this disclosure may be implemented as a combination of both software (e.g., a computer program product) and hardware. Still other embodiments of this disclosure are implemented as entirely hardware, or entirely software.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads.

The embodiments described above are intended to be merely exemplary; numerous variations and modifications will be apparent to those skilled in the art. All such variations and modifications are intended to be within the scope of the present disclosure as defined in any appended claims.

What is claimed is:

1. A method of identifying exfiltration of a file from a computer system via a web browser running under an operating system, the web browser having a URL bar, the method comprising:
detecting, by a session monitor monitoring a first session running under the operating system, initiation of a file upload in the web browser running in the session by:
identifying, using native resources of the operating system and without using a web browser extension and without code injection for said identifying, a head browser process for the web browser; and
detecting, using native resources of the operating system, opening of a file via the web browser;
in response to detecting opening of the file, identifying a uniform resource locator from the web browser by:
identifying, using user accessibility features of the operating system, a window in which the web browser is displayed;
identifying the web browser using user accessibility features of the operating system, said web browser being an identified web browser;
obtaining, from a computer memory, browser heuristics associated with the identified web browser;
identifying, using the browser heuristics associated with the identified web browser, the URL bar of the identified web browser;
reading, using the session monitor, the uniform resource locator from the web browser's URL bar; and
determining that the uniform resource locator is a prohibited URL.

2. The method of claim 1, further comprising, prior to detecting initiation of a file upload in a web browser, detecting initiation of the web browser in the first session, and spawning the session monitor in the first session.

3. The method of claim 1, wherein determining that the uniform resource locator is a prohibited URL comprises determining that the uniform resource locator matches a URL on a list of prohibited URLs.

4. The method of claim 1, wherein determining that the uniform resource locator is a prohibited URL comprises determining that the uniform resource locator is not on a list of allowed URLs.

5. The method of claim 1, further comprising: in response to determining that the uniform resource locator is a prohibited URL: preventing the upload.

6. The method of claim 1, further comprising: in response to determining that the uniform resource locator is a prohibited URL: causing the computer system to take a screenshot of the web browser.

7. The method of claim 1, further comprising: in response to determining that the uniform resource locator is a prohibited URL: alerting an administrator of the computer system.

8. The method of claim 1, further comprising: in response to determining that the uniform resource locator is a prohibited URL: causing the computer system to take a screenshot of the web browser; and alerting an administrator of the computer system by sending the screenshot that administrator.

9. The method of claim 1, further comprising:
detecting initiation of a session on the computer system and, in response to said detecting, spawning the session monitor within the session.

10. The method of claim 1, wherein the method identifies exfiltration of a file from a computer system via a web browser running under an operating system without injecting a Dynamic Link Library (“DLL”) into the address space of the web browser at run-time.

11. The method of claim 1, wherein the method identifies exfiltration of a file from a computer system via a web browser running under an operating system without installing a web browser extension into the web browser, which web browser extension is configured to interact with web pages and the web browser itself to rewrite portions of web page code to capture a pathway by which the web browser initiates file upload activity.

12. A computer-implemented system for identifying exfiltration of a file, the system comprising:
a computer system having a web browser running in a first session under an operating system, the web browser having a URL bar;
a session monitor configured to detect initiation of a file upload in the first session by:
identifying, using resources of the operating system, a head browser process for the web browser; and
detecting, using resources of the operating system, opening of a file via the web browser;
an identifying module configured to identify, in response to detecting opening of the file by the session monitor, a uniform resource locator from the web browser by:
identifying, using user accessibility features of the operating system, a window in which the web browser is displayed;
identifying the web browser using user accessibility features of the operating system;
obtaining, from a computer memory, browser heuristics associated with the web browser;
identifying, using the browser heuristics associated with the web browser, the URL bar of the web browser;
the session monitor further configured to read the uniform resource locator from the web browser's URL bar; and
a determination module configured to determine whether the uniform resource locator is a prohibited URL.

13. The system of claim 12 wherein the determination module is configured to determine whether the uniform resource locator is a prohibited URL by determining that the uniform resource locator matches a URL on a list of prohibited URLs.

14. The system of claim 12 wherein the determination module is configured to determine whether the uniform resource locator is a prohibited URL by determining whether the uniform resource locator is not on a list of allowed URLs.

15. The system of claim 12, further comprising:
a prevention module configured to prevent upload of the file in response to a determination, by the determination module, that the uniform resource locator is a prohibited URL; and
an evidence module configured to take a screenshot of the web browser in response to a determination, by the determination module, that the uniform resource locator is a prohibited URL; and
an alert module configured to alert an administrator of a computer system in response to a determination, by the determination module, that the uniform resource locator is a prohibited URL.

16. The system of claim 12 further comprising a spawning module configured to detect initiation of a session on the computer system and, in response to said detection, to spawn the session monitor within the first session.

17. A non-transitory computer-readable medium having computer executable code thereon, the computer executable code, when executed by a computer system, causing the computer system to perform a method, the code comprising:
code for detecting, by a session monitor monitoring a session, initiation of a file upload in a web browser running in the session by:
identifying, using resources of the operating system, a head browser process for the web browser; and
detecting, using resources of the operating system, opening of a file via the web browser;
code for identifying, in response to detecting opening of the file, a uniform resource locator from the web browser by:
identifying, using user accessibility features of the operating system, a window in which the web browser is displayed;
identifying the web browser using user accessibility features of the operating system;
obtaining, from a computer memory, browser heuristics associated with the web browser;
code for identifying, using the browser heuristics associated with the web browser, the URL bar of the web browser;
code for reading, using the session monitor, the uniform resource locator from the web browser's URL bar; and
code for determining that the uniform resource locator is a prohibited URL.

18. The non-transitory computer-readable medium of claim 17, wherein code for determining that the uniform resource locator is a prohibited URL comprises:
code for determining that the uniform resource locator is on a list of prohibited URLs.

19. The non-transitory computer-readable medium of claim 17, wherein code for determining that the uniform resource locator is a prohibited URL comprises:
code for determining that the uniform resource locator is not on a list of permitted URLs.

20. The non-transitory computer-readable medium of claim 17, further comprising at least one of:
code for preventing upload of the file in response to determining that the uniform resource locator is a prohibited URL;
code for causing the computer system to take a screenshot of the web browser in response to determining that the uniform resource locator is a prohibited URL; and
code for alerting an administrator of the computer system by sending the screenshot to that administrator.
